(19) United States
(12) Patent Application Publication
(10) Pub. No.: US 2017/0259465 A1
(43) Pub. Date: Sep. 14, 2017

(54) FIBER COMPOSITE MATERIAL, METHOD FOR MANUFACTURING A COMPOSITE COMPONENT, AND USE THEREOF

(71) Applicants: ThyssenKrupp Steel Europe AG, Duisburg (DE); thyssenkrupp AG, Essen (DE)

(72) Inventors: Peter Klauke, Schwerte (DE); Oliver Kleinschmidt, Dortmund (DE); Tobias Lewe, Münster (DE)

(73) Assignees: ThyssenKrupp Steel Europe AG, Duisburg (DE); thyssenkrupp AG, Essen (DE)

(21) Appl. No.: 15/531,760

(22) PCT Filed: Oct. 26, 2015
(86) PCT No.: PCT/EP2015/074751

§ 371 Date: May 31, 2017

(30) Foreign Application Priority Data
Dec. 1, 2014 (DE) 10 2014 224 522.2

(51) Int. Cl. B29C 35/02; B29C 35/08

(52) U.S. Cl. CPC B29C 35/0272; B29C 35/0805; B29C 2035/0811; B29L 2031/3002

(57) ABSTRACT

The disclosure relates to a preimpregnated fibrous composite material comprising, at least, one or more plies of sheetlike textile structures in the form of wovens, meshed fabrics, knitted fabrics, braided fabrics, stitch-bonded fabrics, nonwovens or felts of organic and inorganic fibers in a polymeric matrix. A method of manufacturing a fibrous composite component part and use thereof.

### FIELD

The disclosure relates to a preimpregnated fibrous composite material comprising, at least, one or more plies of sheetlike textile structures in the form of wovens, meshed fabrics, knitted fabrics, braided fabrics, stitch-bonded fabrics, nonwovens or felts of organic and inorganic fibers in a polymeric matrix. A method of manufacturing a fibrous composite component part and use thereof are further provided.

### BACKGROUND

Fibrous composite materials of the type in question are known in the prior art. For instance, German laid open document 26 05 508 discloses a fiber-reinforced plastics article formed from a resin-impregnated blend of glass fiber and steel wool and shaped into a plastics motor vehicle body part, in particular into a part of a hood or bonnet top. The steel wool is said to provide shielding against radio frequency interference due to the ignition system of the internal combustion engine for example. Reinforcement, by contrast, is primarily provided by the glass fiber.

German publication 11 2010 001 365 discloses a laminate for a vehicular exterior trim material between a fibrous mat—in which molten binder resin fibers bind together inorganic fibers and heat-resistant organic fibers having a melting point of 200° C. or more—and a polymeric film laminated in one piece onto at least one surface of the fibrous mat, wherein part of the polymeric film impregnates the fibrous mat by melting. The vehicular exterior trim materials of this type are particularly used for vehicle underbodies on account of their very high resistance to chipping. The inorganic fibers, comprising between 15 and 60 wt % of the fibrous mat, are preferably glass fibers because of their ease of handling, which influence the mechanical properties of the vehicular exterior trim material according to their weight fraction. The heat-resistant organic fibers used, comprising between 5 and 60 wt % of the fibrous mat, are preferably polyethylene terephthalate fibers which influence the impact strength of the vehicular exterior trim material depending on their weight fraction. The binder resin fibers used, comprising between 10 and 40 wt % of the fibrous mat, are preferably polypropylene fibers. To produce a fibrous mat, the aforementioned fibers are entangled by needling. The fibrous mat is subsequently laminated, on one or both of its sides, with a polymeric film in a lamination process involving the application of pressure and heat to produce and compress a laminate web, while constituents out of the polymeric film are caused by the heating to impregnate the fibrous mat and the binder resin fibers in the fibrous mat melt to bind the inorganic and heat-resistant organic fibers together. As the pressure exerted on the laminate web goes back down, the resilience of the inorganic fibers causes the laminate web to expand in the thickness direction and the fibrous mat develops internal pores, the proportion of which may be between 30 and 90%. Cooling provides a low-weight laminate for thermoforming into a vehicular exterior trim material.

Vehicles equipped with component parts as described in the prior art may admittedly be able to contribute to some weight reduction and hence to some reduction in motor fuel consumption, yet component parts of this type are typically only bondable to further components in the vehicle via relatively costly adhesive bonds or further mechanical bonds requiring, for example, a separate processing technology. Existing fibrous composite materials further have no ground potential (contact 31). As typical electrical nonconductors, there is then a need for additional return conductors and burdensome cabling, which have to be additionally installed and have adverse consequences in the form of increased weight.

### SUMMARY

Proceeding therefrom, the present invention has for its object to propose a fibrous composite material that overcomes the aforementioned disadvantages and also to specify a cost-effective method of manufacturing a composite component part and also the use thereof.

The stated object is achieved for a fibrous composite material of the type in question when the fibrous composite material comprises not less than 40% by volume of electrically conductive fibers, wherein fibers of aluminum, of magnesium and/or of steel are used as electrically conducting fibers.

It was found that electrically conductive fibers provide at least a ground potential in a fibrous composite material and therefore the fibrous composite material combines lower weight with comparable properties to an all-metallic material, making it possible to eschew additional return conductors and burdensome cabling. The proportion of electrically conductive fibers in the form of aluminum, magnesium and/or steel fibers in the fibrous composite material is not less than 40% by volume, especially not less than 50% by volume, preferably not less than 60% by volume and more preferably not less than 70% by volume, making the fibrous composite material specifically also resistance weldable to further components in a conventional and cost-effective manner.

### DETAILED DESCRIPTION

In a first embodiment of the invention, the inorganic fibers consist of metal wool, which by virtue of its electrical conductivity is used as electrically conductive fibers in the fibrous composite material. It is similarly possible to use hybrid yarns whose cores consist of metal fibers. Steel wool is preferable for use as electrically conductive fibers. Steel is particularly preferable because steel is an engineering material which is very elastic and relatively inexpensive to purchase. Owing to the advantageous magnetic property of steel, any transport/transfer of fibrous composite materials is relatively simple to put into practice by means of magnets for example. The proportion of inorganic fibers is limited to not more than 90% by volume, especially to not more than 85% by volume, in order to still retain some weight advantage over an all-metallic material having comparable dimensions. A further advantage in weight is possible by using, for example, metal powder cored wires, in particular having a steel material as sheath and aluminum powder as core material. Metal powder cored wires and also their methods of making are known in the prior art for welding applications, yet the diameter must be appropriately reduced by using suitable means, the diameter being guided essentially by the diameter of steel fibers and/or steel wool.

A further embodiment of the invention provides that the organic fibers of the fibrous composite material consist of PA, PP, PE, regenerated, natural, aramid (para-aramid, meta-aramid), polyester (HT), viscose (FR), PET, Polycolon or melamine fibers, thermoplastic or mixtures thereof, and/or may else consist completely of at least two or more different fibers in the form of a specifically layerwise united hybrid yarn. Natural fibers are used with preference and are specifically in combination with steel fibers/steel wires and/or steel wool recyclable in an environmentally friendly manner, which also serves to improve the life-cycle assessment.

A further embodiment of the invention provides that the organic and/or inorganic fibers are used in the form of hybrid fibers, which more particularly are inexpensive to produce and provide.

In a further embodiment of the invention, the fibrous composite material is one- or both-sided provided a covering layer, which is bondable to the fibrous composite material in an essentially adhesive bonded manner. Providing a covering layer may, for example, rectify unevennesses at the surface of the fibrous composite material and improve appearance.

The manufacture of fibrous composite materials of the type in question, in particular under application of heat and/or pressure, for example via double belt presses or other suitable laminating equipment, is described in the prior art. Alternatively, fibrous composite materials are also obtainable in a load-specific manner, for example individually adjustable in fiber orientation via the automated fiber placement (AFP) process.

A further aspect of the invention relates to a method of manufacturing a fibrous composite component part wherein a fibrous composite material preconsolidated according to the invention is conductively and/or inductively heated to a molding temperature and is subsequently molded in a mold into a fibrous composite component part. Alternatively, the fibrous composite material is also heatable passively.

By virtue of the electrically conductive fibers in the fibrous composite material, the utilization of energy- and cost-intensive devices for heating, as for example any heating in ovens, is eschewable and relatively cost-effective, conductive and/or inductive heating means are usable. The fibrous composite material is preferably heated to a temperature, particularly to the molding temperature. The means for conductive and/or inductive heating may be integrated in the mold for example. Alternatively or cumulatively, the means for conductive and/or inductive heating may be arranged outside the mold, being for example integrated in a transfer device which, for example, transfers the specifically cut-to-size fibrous composite materials from a stack into the mold whilst heating. This may serve specifically to increase the cycle time. In a first embodiment of the method according to the present invention, the polymeric matrix of the fibrous composite component part is cured in the mold. Said curing is essentially effected under heat and/or pressure, while the temperature may more particularly be chosen to be higher than for instance the molding temperature. Advantageously, the mold is equipped with means for temperature-regulating the mold.

In a further aspect, the invention relates to the method of using the fibrous composite component part obtained by the method of the present invention. Component parts having a large area, for example parts of vehicle roofs, doors or lids are suitable in particular. Component parts of this type combine the property of having a ground potential with low weight. To avoid repetition, the above is referenced.

A first working example provides a preimpregnated fibrous composite material, obtained via AFP for example, having two or more layers of organic and inorganic fibers in a polymeric matrix. The inorganic fibers used were electrically conductive fibers in the form of steel fibers and/or steel wool at 60% by volume. Natural fibers accounted for the remaining 40% by volume. The polymeric matrix used was an epoxy resin. One of the cut-to-size preimpregnated fibrous composite materials was lifted from a stack and transferred in mold direction using, for example, a handling device or a robot. Contacting elements integrated in the grippers of the transfer device were in connection with a source of electricity and in direct contact with the fibrous composite material which, as part of the electric circuit and owing to very good electrical conductivity in the fibrous composite material, was heated up on being subjected to the flow of an electric current. The transfer device placed the heated fibrous composite material into an open mold consisting, for example, of a lower “female” half and an upper “male” half. A relative movement between the two halves of the mold caused the warm fibrous composite material to be shaped into a fibrous composite component part. Temperature-regulating means integrated in the mold maintained the mold at a preset temperature, this having been chosen at a sufficiently high level to ensure curing of the epoxy resin in the closed state (at molding temperature) of the mold, i.e., under heat and pressure. Subsequently, the mold was opened and the ready-shaped fibrous composite component part was removed.

A second working example provided a preimpregnated fibrous composite material having two or more plies of hybrid yarn textile fabrics, which was processed on a double belt press into an organopanel, the hybrid yarn comprising a preferably homogeneous blend of steel fibers at 65% by volume and thermoplastic fibers at 35% by volume, the thermoplastic fibers being specifically continuous-filament and undrawn fibers. The cut-to-size fibrous composite material was lifted from a stack and transferred in the mold direction using, for example, a handling device or a robot. An inductor arranged, above the gripper, on the transfer device was in connection with a source of electricity and, by virtue of its arrangement, ensured a consistent pickup and laydown of a fibrous composite material. Owing to the ferromagnetic properties of the steel fibers in the fibrous composite engineering material, application of an electric current caused the fibrous composite material to heat up through induction. The transfer device placed the heated fibrous composite material into an open mold. The further steps took place similarly to the first example to produce a ready-shaped and cured fibrous composite component part.

Alternatively or cumulatively, conductive and/or inductive heating means may also be integrated in the mold.

The fibrous composite component parts manufactured according to the present invention are specifically useful as part of a motor vehicle roof but also for further component parts having a large area, for example parts of doors and lids in the vehicle. Component parts thus provided have a ground potential coupled with low weight and, more particularly, are suitable for resistance welding. Moreover, recyclable materials are employable to improve the life-cycle assessment. The use of fibrous composite component parts manufactured according to the present invention is not limited to vehicle construction, but may also be employed in sectors requiring a ground potential combined with low weight, for example aerospace, shipbuilding.

1. A preimpregnated fibrous composite material comprising: at least, one or more plies of sheetlike textile structures in the form of wovens, meshed fabrics, knitted fabrics, braided fabrics, stitch-bonded fabrics, nonwovens or felts of organic and inorganic fibers in a polymeric matrix;
wherein the fibrous composite material comprises not less than 40% by volume of electrically conductive fibers, wherein fibers of aluminum, of magnesium and/or of steel are used as electrically conducting fibers.

2. The fibrous composite material as claimed in claim 1, wherein the inorganic fibers consist of metal wool.

3. The fibrous composite material of claim 2 wherein the organic fibers consist of at least one of natural, regenerated, aramid, polyester, viscose, Polycon, melamine, PET, PP, PE and PA fibers.

4. The fibrous composite material according to claim 3 wherein the at least one of organic and/or inorganic fibers are used in the form of hybrid fibers.

5. The fibrous composite material of claim 1 wherein the fibrous composite material is one- or both-sided provided a covering layer.

6. A method of manufacturing a fibrous composite component part, the fibrous composite component part having at least, one or more plies of sheetlike textile structures in the form of wovens, meshed fabrics, knitted fabrics, braided fabrics, stitch-bonded fabrics, nonwovens or felts of organic and inorganic fibers in a polymeric matrix;
wherein the fibrous composite material comprises not less than 40% by volume of electrically conductive fibers, wherein fibers of aluminum, of magnesium and/or of steel are used as electrically conducting fibers one of conductively and inconductively heating the fibrous composite material to a molding temperature; and
subsequently molding the fibrous composite material in a mold into a fibrous composite component part.

7. The method as claimed in claim 6; further comprising: curing the polymeric matrix of the fibrous composite component part is cured in the mold.

8. The method of claim 7; further comprising: incorporating the fibrous composite component as part of one of a vehicle roof, of a door and of a lid.
